(19) United States
(12) Patent Application Publication
(10) Pub. No.: US 2012/0145980 A1
(43) Pub. Date: Jun. 14, 2012

(54) MOUNTING BRACKET

(75) Inventor: Gary Harrison, Wellington (GB)

(73) Assignee: Oldbury UK Limited

(21) Appl. No.: 13/316,772

(22) Filed: Dec. 12, 2011

(30) Foreign Application Priority Data
Dec. 10, 2010 (GB) 1020951.8

(51) Int. Cl. F16M 13/02; B66D 3/26; B60R 11/00

(52) U.S. Cl. 254/323; 248/674

(57) ABSTRACT

A winch mounting bracket for attaching to a vehicle has coupling points arranged and adapted for engagement with corresponding anchor points on the vehicle to secure releasably the winch unit to the vehicle. The coupling points include a sleeve and a pair of latch pins. The sleeve is positioned between the latch pins and arranged to engage a pin or hook on the vehicle. The pins are slidable to engage holes in the vehicle and are biased to a latching position to maintain engagement with the holes.

### FIELD

This invention relates to a mounting bracket and in particular to a mounting bracket for mounting a winch on a vehicle. The winch can be a powered winch or a hand operated winch.

### BACKGROUND

It is known to attach powered winches to a vehicle by means of bolts extending through aligned holes in a part of the winch, for example a base plate, and in a part of the vehicle, for example the chassis, and attaching nuts to the bolts to secure the two parts of the winch and vehicle to each other. Typically, access to such fastening means is restricted so that releasing the fastening means can be difficult and time consuming. As a result, once attached to the vehicle, the winches often remain in place permanently until requiring repair or replacement or the vehicle is scrapped.

### SUMMARY

The present invention has been made from a consideration of the foregoing and seeks to provide an improved apparatus for and method of attaching a winch to a vehicle. More especially, a preferred aim of the present invention is to provide an apparatus and method that allows a winch to be readily attached to and detached from a vehicle.

In one aspect, the present invention provides a winch mounting bracket for attaching to a vehicle, the bracket having at least two coupling points arranged and adapted for engagement with corresponding anchor points on the vehicle to secure releasably the bracket to the vehicle.

The coupling points may include at least one latch pin for engagement with a hole at an anchor point on the vehicle. The latch pin may be biased, for example by a spring, to a latching position in which the latch pin is received in the hole when the bracket is secured to the vehicle.

The coupling points may include at least one sleeve for engagement with a locking pin at an anchor point on the vehicle. The sleeve may be connected to a pivot pin that allows the sleeve to be swung to a position in which the pivot pin can engage a hook at an anchor point on the vehicle.

In a preferred embodiment, the bracket has a three point coupling system with a centre coupling point and two outer coupling points disposed on either side of the centre coupling point. In this embodiment, the centre coupling point is a sleeve and the outer coupling points are latch pins.

In another aspect, the present invention provides a demountable winch unit for attaching to a vehicle.

Preferably, the winch unit has one or more coupling points for releasable engagement with one or more anchor points on the vehicle.

Preferably, the winch unit includes a bracket according to the previous aspect of the invention for releasably connecting the winch unit to the vehicle.

Preferably, the winch unit includes a cable reel and a motor for rewinding a cable on the cable reel.

Preferably, the winch unit include a cover for the cable reel and motor.

In a further aspect, the present invention provides a vehicle and a detachable winch unit releasably connected to the vehicle by co-operating connector means on the winch unit and vehicle.

Preferably, the connector means on the vehicle comprise one or more anchor points and the connector means on the winch unit comprise one or more coupling points.

The coupling point(s) on the winch unit may be provided by a mounting bracket to which a cable reel and motor may be attached.

Preferably, the co-operating connector means can be engaged and disengaged without any tools being required.

The mounting bracket may be in accordance with any preceding aspect of the invention.

The invention will now be described in more detail by way of example only with reference to the accompanying drawings.

### BRIEF DESCRIPTION OF THE DRAWINGS

FIG. 1 is a front perspective view of a winch unit embodying the invention:

FIG. 2 is a rear perspective view of the winch unit shown in FIG. 1;

FIG. 3 is a rear perspective view similar to FIG. 2 with the locating sleeve in an alternative position;

FIG. 4 is a rear perspective view of the mounting bracket of the winch unit shown in FIGS. 1 to 3;

FIG. 5 is a perspective view of part of a vehicle showing attachment points on the vehicle for connecting the winch unit of FIGS. 1 to 4 to the vehicle;

FIG. 6 is a perspective view showing the winch unit positioned for connection to the attachment points on the vehicle shown in FIG. 5;

FIG. 7 is a perspective view showing the winch unit connected to the attachment points on the vehicle shown in FIGS. 5 and 6;

FIG. 8 is a perspective view from above of the winch unit connected to the attachment points on the vehicle shown in FIG. 7;

FIG. 9 is a perspective view of part of a vehicle showing alternative attachment points on the vehicle for connecting the winch unit of FIGS. 1 to 4 to the vehicle;

FIG. 10 is a perspective view showing the winch unit positioned for connection to the attachment points on the vehicle shown in FIG. 9; and

FIG. 11 is a perspective view showing the winch unit connected to the attachment points on the vehicle shown in FIGS. 9 and 10.

### DETAILED DESCRIPTION OF EXEMPLARY EMBODIMENTS

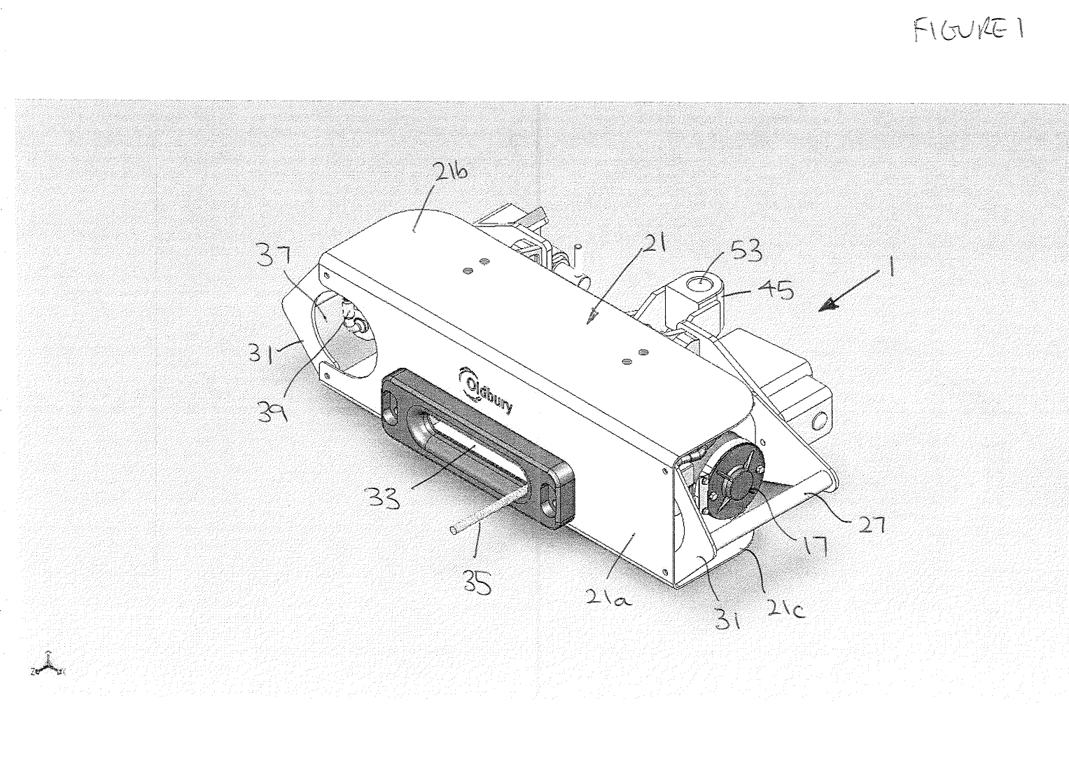

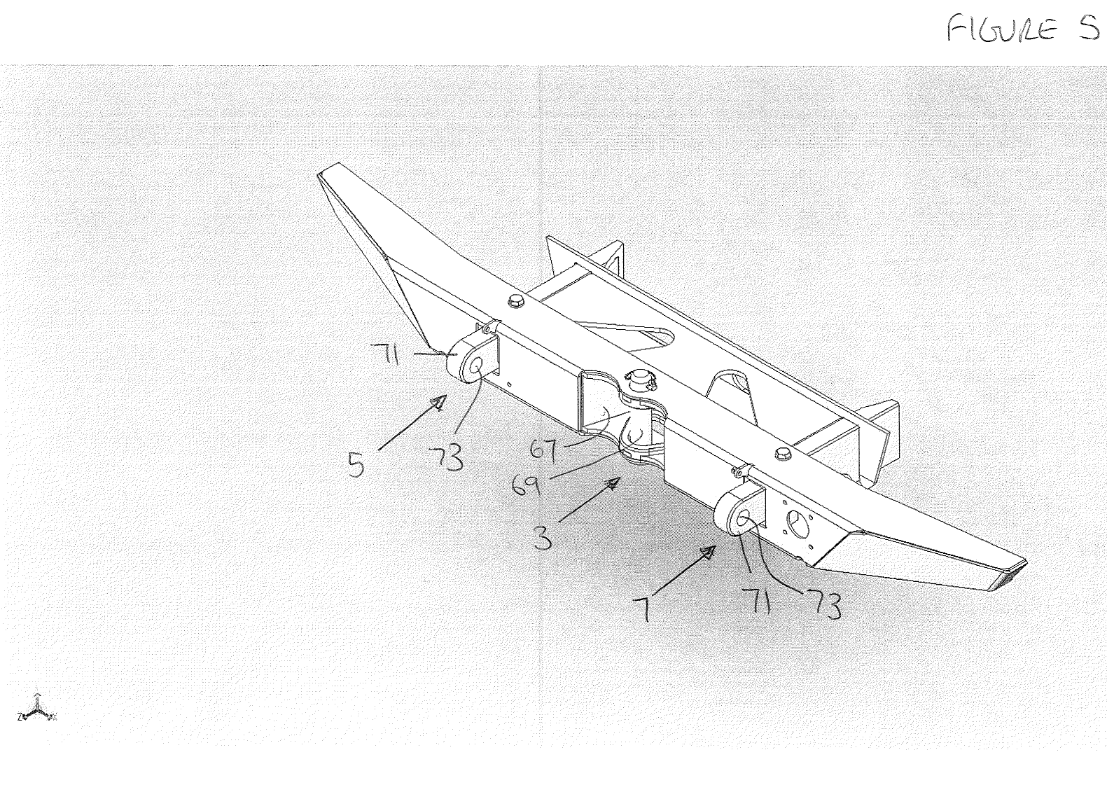

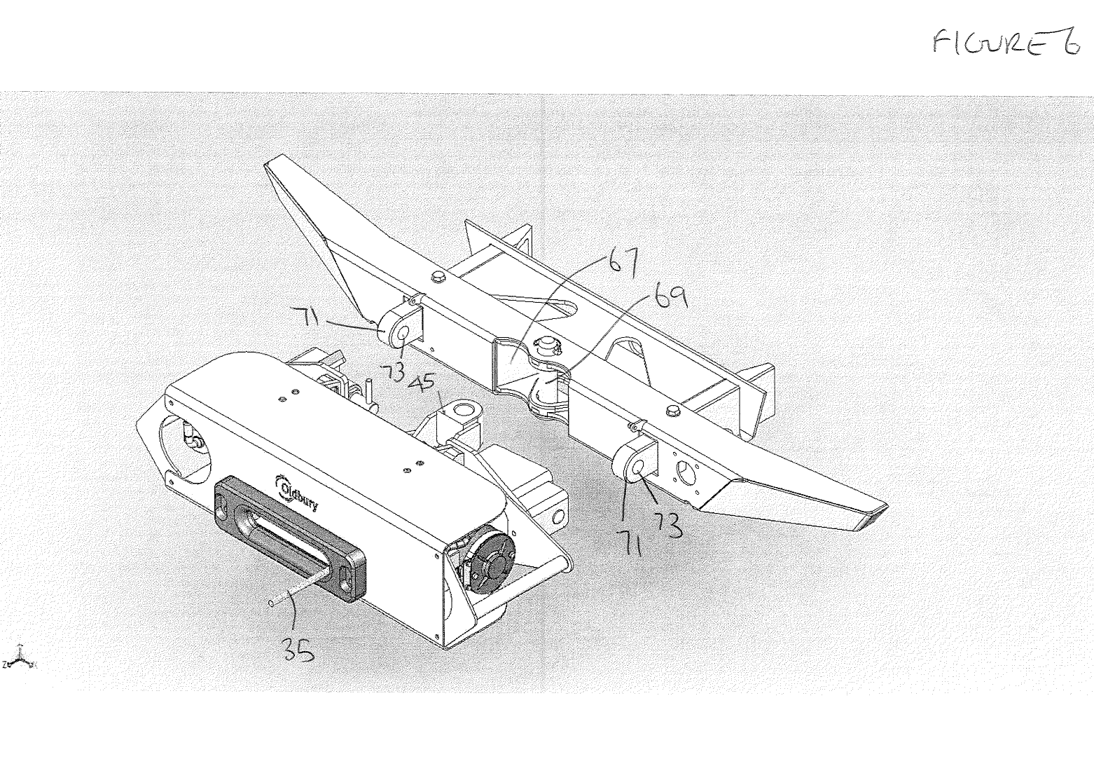

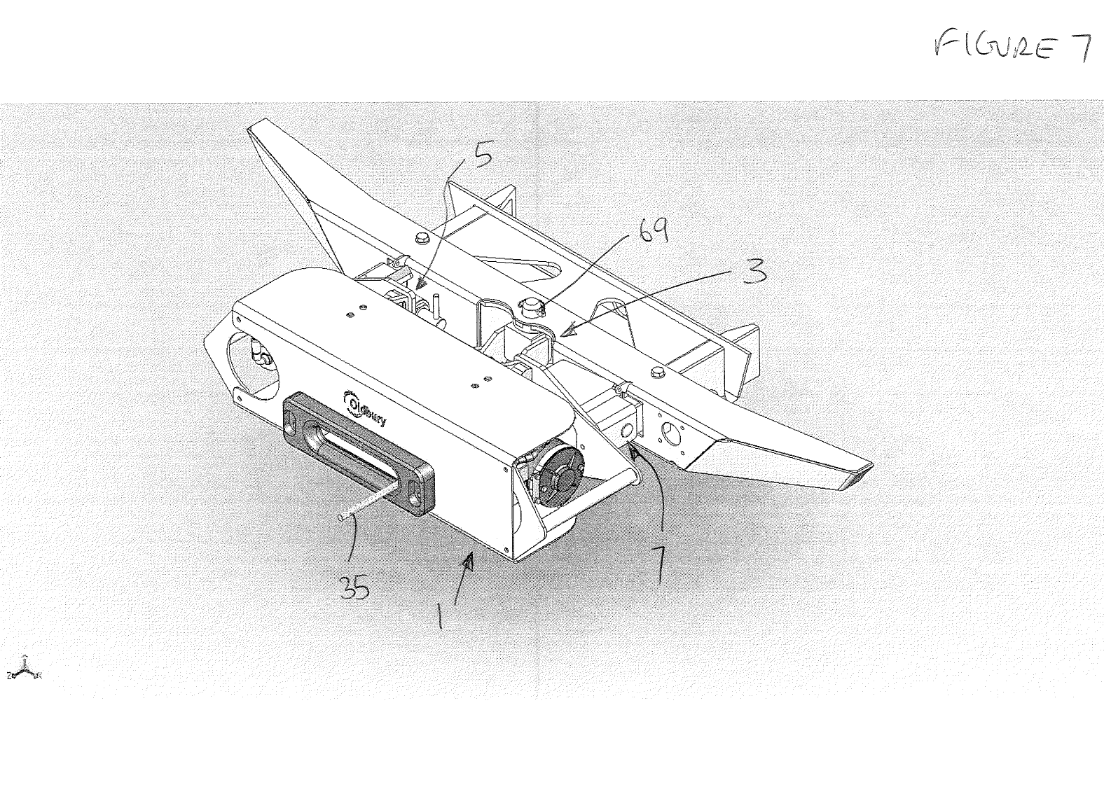

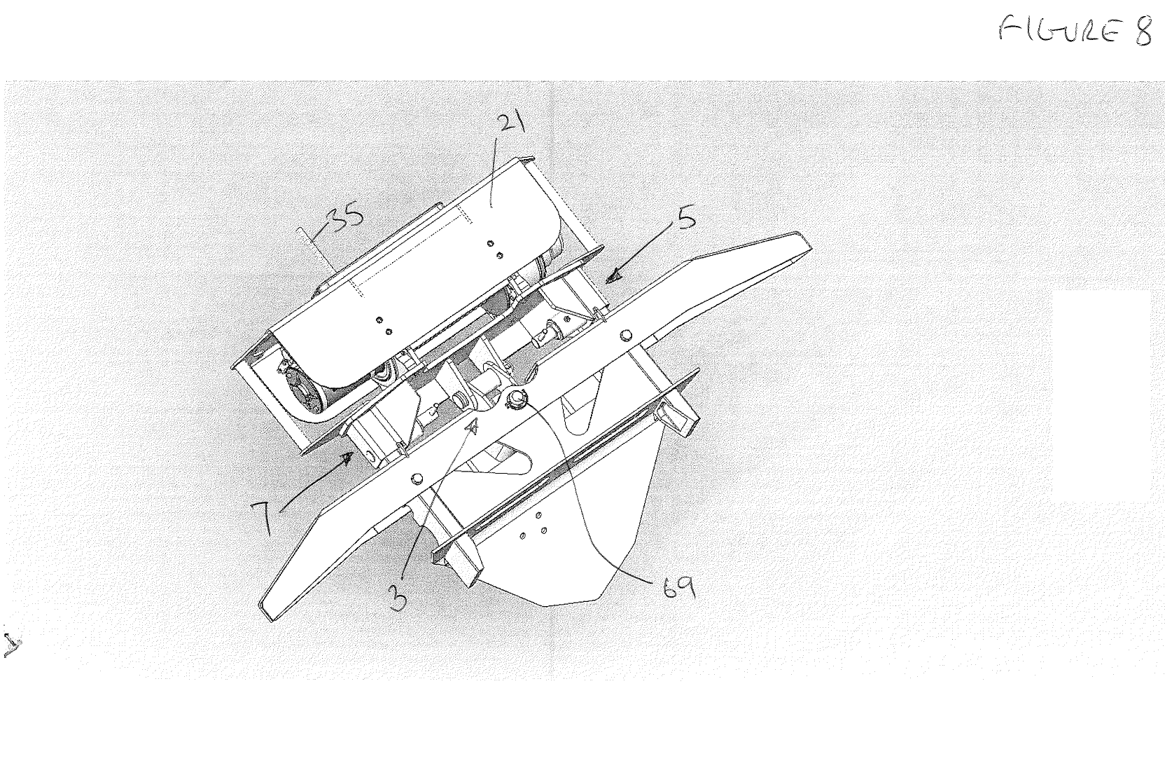

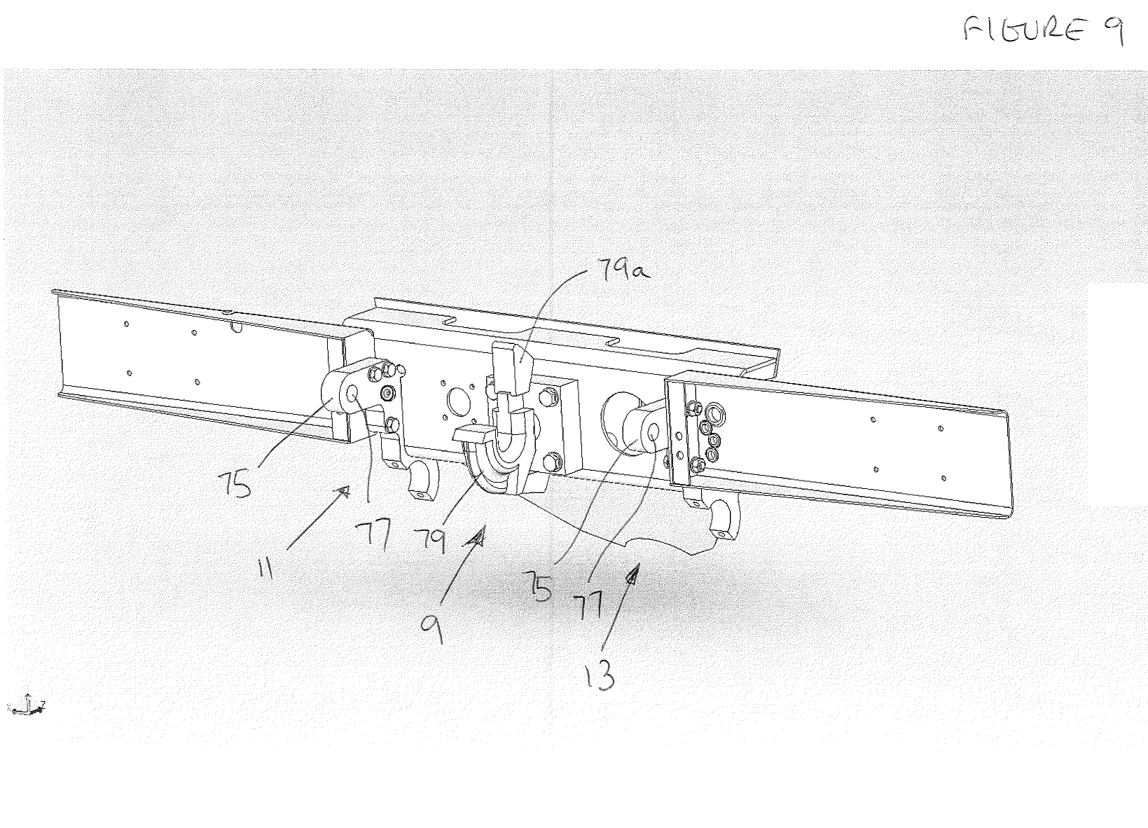

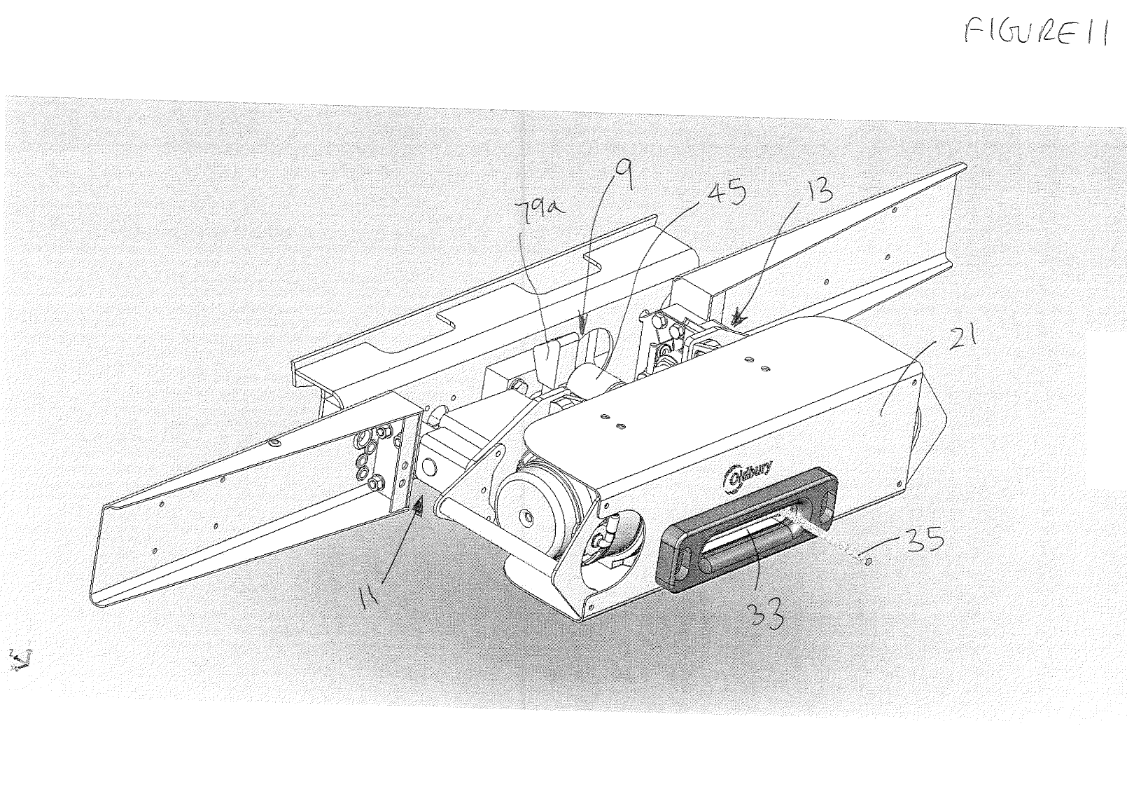

In the accompanying drawings FIGS. 1 to 4 depict a winch unit 1 embodying the invention. FIGS. 5 and 6 depict part of a vehicle having a three point anchoring system with anchor points 3,5,7 for connecting the winch unit 1 to the vehicle and FIGS. 7 and 8 depict the winch unit 1 connected to the anchor points 3,5,7. FIG. 9 depicts part of a vehicle having alternative three point anchoring system with anchor points 9,11,13 for connecting the winch unit 1 to the vehicle and FIG. 11 depicts the winch unit 1 connected to the anchor points 9,11,13. The anchor points 3,5,7 and 9,11,13 are typically connected to a part of the vehicle such as the frame or chassis that is capable of withstanding the forces generated during operation of the winch unit 1.

In this embodiment the anchor points 3,5,7 are provided at the front of the vehicle and the anchor points 9,11,13 are provided at the rear of the vehicle. In this way, the winch unit 1 can be connected to the vehicle at the front or back. Also in this embodiment, the winch unit 1 is releasably connectable to the vehicle so as to be demountable. In this way, the winch unit 1 can be moved from the front of the vehicle to the back and vice versa. It will be understood that the winch unit 1 can also be connected to any vehicle provided with one or both sets of anchor points 3,5,7 or 9,11,13.

Referring now to FIGS. 1 to 4, the winch unit 1 includes a cable reel 15, an electric motor 17, a mounting bracket 19 and a cover 21. The bracket 19 has a base plate 23 with through holes 25 for fasteners such as bolts (not shown) by means of which the cable reel 15 and electric motor 17 are attached to the bracket 19 on one side of the base plate 23. The cover 21 is connected to the bracket 19 at each end of the base plate 23 by a tie rod 27 extending between a pair of plates 29,31 connected to the base plate 23 and cover 21 by fasteners such as bolts (not shown). The cover 21 is of channel-section with a base wall 21a and side walls 21b,c and forms with the base plate 23 a generally box-section housing for protecting the cable reel 15 and electric motor 17.

The base wall 21a of the cover 21 has an elongate opening 33 for passage of a winch cable 35 wound on the cable reel 15. An aperture 37 at one end of the base wall 21a provides access to a handle 39 or other suitable actuator for manually operating a mechanism (not shown) controlling the drive between the electric motor 17 and the cable reel 15. The drive can be disconnected to allow free-spooling of the cable reel 15 for manually unwinding the winch cable 35 and can be re-connected for powered re-winding of the winch cable 35 by rotating the cable reel 15 with the motor 17. In a modification (not shown) the motor may be reversible for powered unwinding and re-winding of the winch cable 35.

The bracket 19 is adapted for releasably connecting the winch unit 1 to a vehicle so that the winch unit 1 is detachable for mounting and de-mounting the winch unit 1. In this way, the winch unit 1 can be fitted when required for use and removed after use for storage until next required. In this way, the winch unit 1 does not have to remain permanently in place on the vehicle and the risk of the winch unit 1 being damaged by collisions or impacts with other objects is reduced. Also, the winch unit 1 may be used with several vehicles so that a dedicated winch unit 1 does not have to be fitted to each vehicle. The releasable connection is preferably manually operable so that the winch unit 1 can be easily attached to and detached from a vehicle.

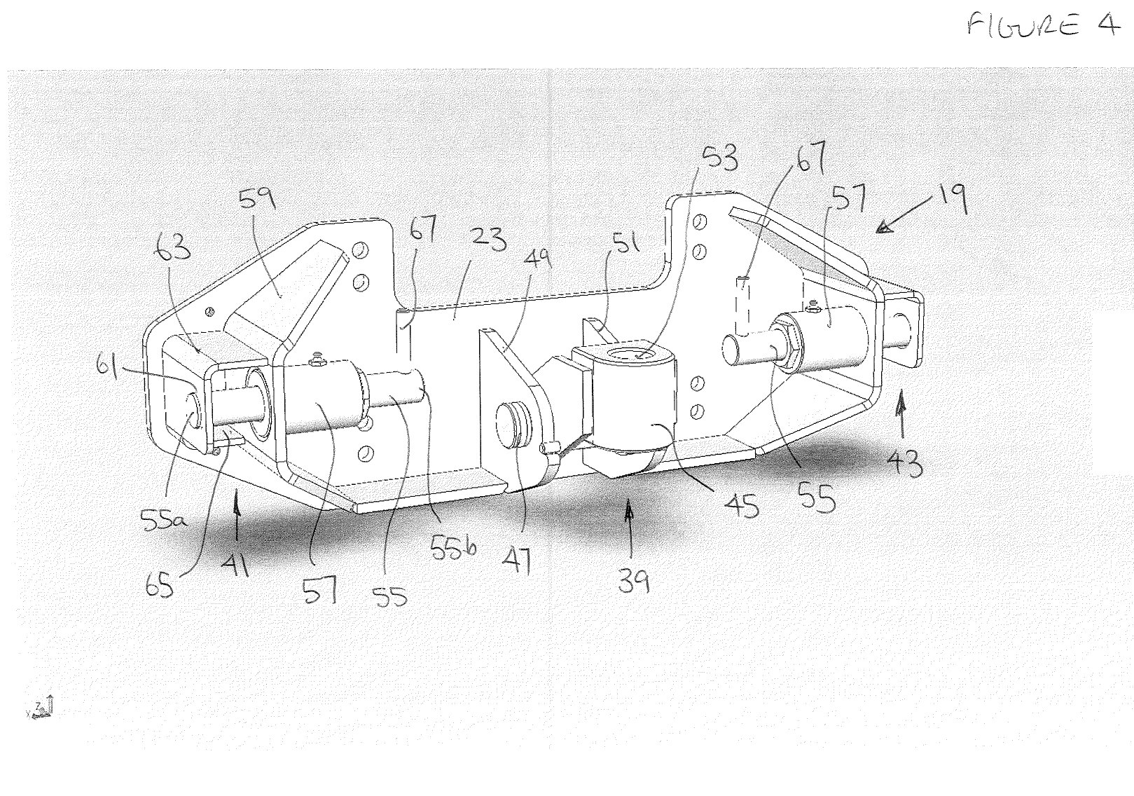

In this embodiment, the bracket 19 is provided with a three point coupling system on the opposite side of the base plate 23 to the cable reel 15 and electric motor 17 for connection to a vehicle provided with a mateable three point anchoring system. As best shown in FIG. 4, the three point coupling system on the bracket 19 includes a centre coupling point 39 and two outer coupling points 41,43 disposed either side of the centre coupling point 39.

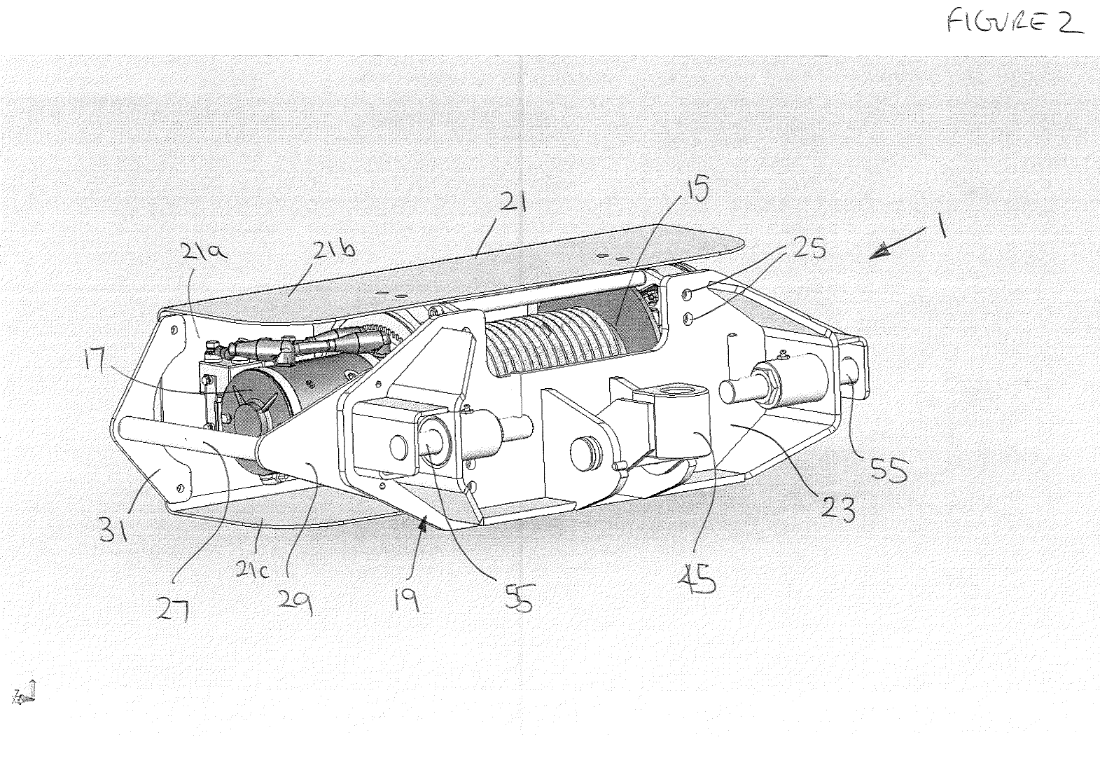

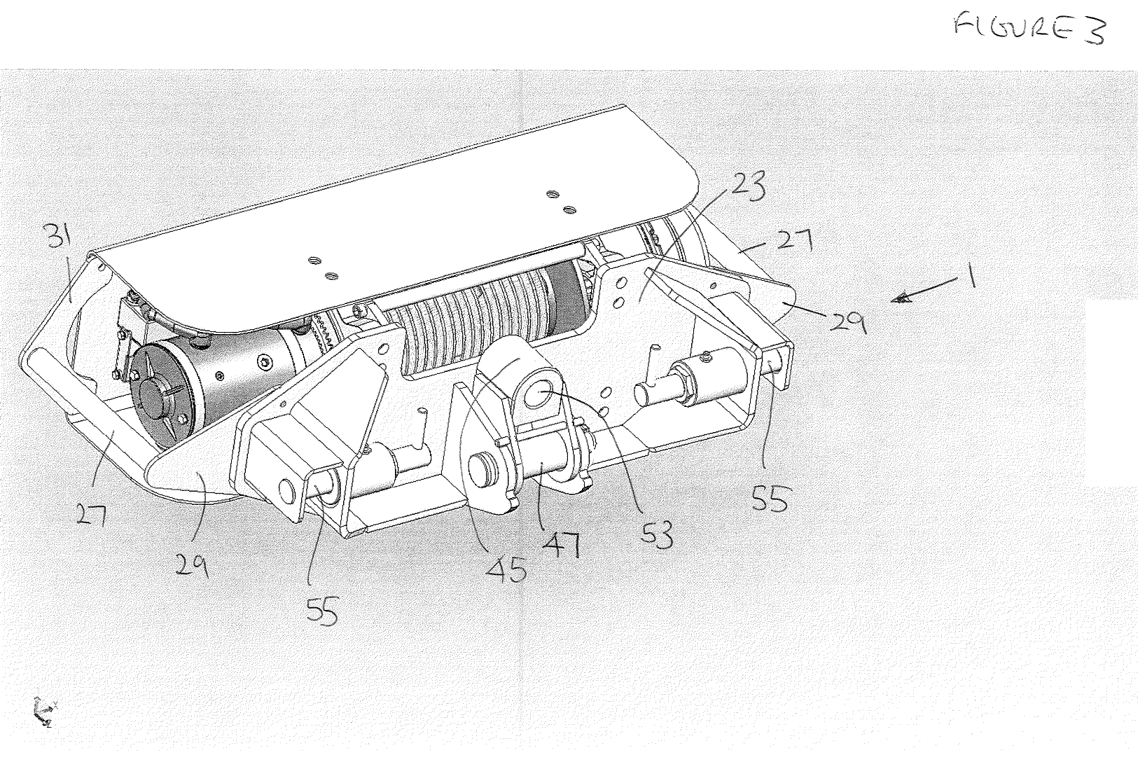

The centre coupling point 39 comprises a sleeve 45 attached to a pivot pin 47 mounted between a pair of lugs 49,51 welded or otherwise attached to the base plate 23. The sleeve 45 can be swung through approximately 90 degrees from the position shown in FIGS. 2 and 4 in which the sleeve 45 is disposed so that through bore 53 extends generally parallel to the base plate 23 and the position shown in FIG. 3 in which the through bore 53 extends generally normal to the base plate 23 for a purpose described later.

The outer coupling points 41,43 are similar and each comprises a latch pin 55 that extends through a housing 57 supported on a generally C-shaped web 59 welded or otherwise attached to the base plate 23. The latch pin 55 is biased by a spring (not shown) contained in the housing 57 to an operative position in which an outer end 55a of the pin 55 is received in an opening 61 in a further plate 63 welded or otherwise attached to the base plate 23 and web 59. The plate 63 forms a recess 65 with the web 57 and the latch pin 55 extends across the recess 65 under the biasing of the spring. The inner end 55b of the latch pin 55 projects from the housing 57 and is provided with a lever 67 by means of which the latch pin 55 can be gripped and manually displaced against the biasing of the spring to withdraw the outer end 55a from the opening 61 into the housing 57 clear off the recess 65 for a purpose described later.

Referring now to FIGS. 5 to 8, the anchor points 3,5,7 of the three point anchoring system on the front of the vehicle include a centre anchor point 3 and two outer anchor points 5,7 disposed either side of the centre anchor point 3.

The centre anchor point 3 comprises a recess 67 and a locking pin 69 that extends across the mouth of the recess 67. The locking pin 69 is removable to allow the sleeve 45 on the winch unit 1 to be inserted in the recess 67 with the sleeve in the position shown in FIG. 6. Thereafter the sleeve 45 is secured and retained in the recess 67 by replacing the locking pin 69 to extend through the bore 53 in the sleeve 45 as shown in FIGS. 7 and 8.

The outer anchor points 5,7 are similar and each comprises a lug 71 that extends forwardly and is provided with a through hole 73. The lugs 71 are received in the recesses 65 of the outer coupling points 41,43 on the winch unit 1 when the latch pins 55 on the winch unit 1 are withdrawn. Thereafter the lugs 71 are secured and retained in the recesses 65 by releasing the latch pins 55 to extend through the holes 73 in the lugs 71 to engage the openings 61 on the other side of the recesses 65 under the biasing of the springs as shown in FIGS. 7 and 8. In a modification (not shown) the outer end 55a of the latch pins 55 may project from the openings 61 to allow a retainer to be fitted that prevents the latch pins 55 being withdrawn to release the lugs 71 until the retainer has been released. In this way accidental release of the lugs 71 is prevented.

Referring now to FIGS. 9 to 11, the anchor points 9,11,13 of the three point anchoring system on the rear of the vehicle include a centre anchor point 9 and two outer anchor points 11,13 disposed either side of the centre anchor point 9.

The outer anchor points 11,13 are similar to the outer anchor points 5,7 on the front of the vehicle and each comprises a lug 75 with a through hole 77. The lugs 75 are secured and retained in the recesses 65 of the winch unit 1 by the latch pins 55 on the winch unit 1 as shown in FIG. 11 similar to the lugs 71 described previously.

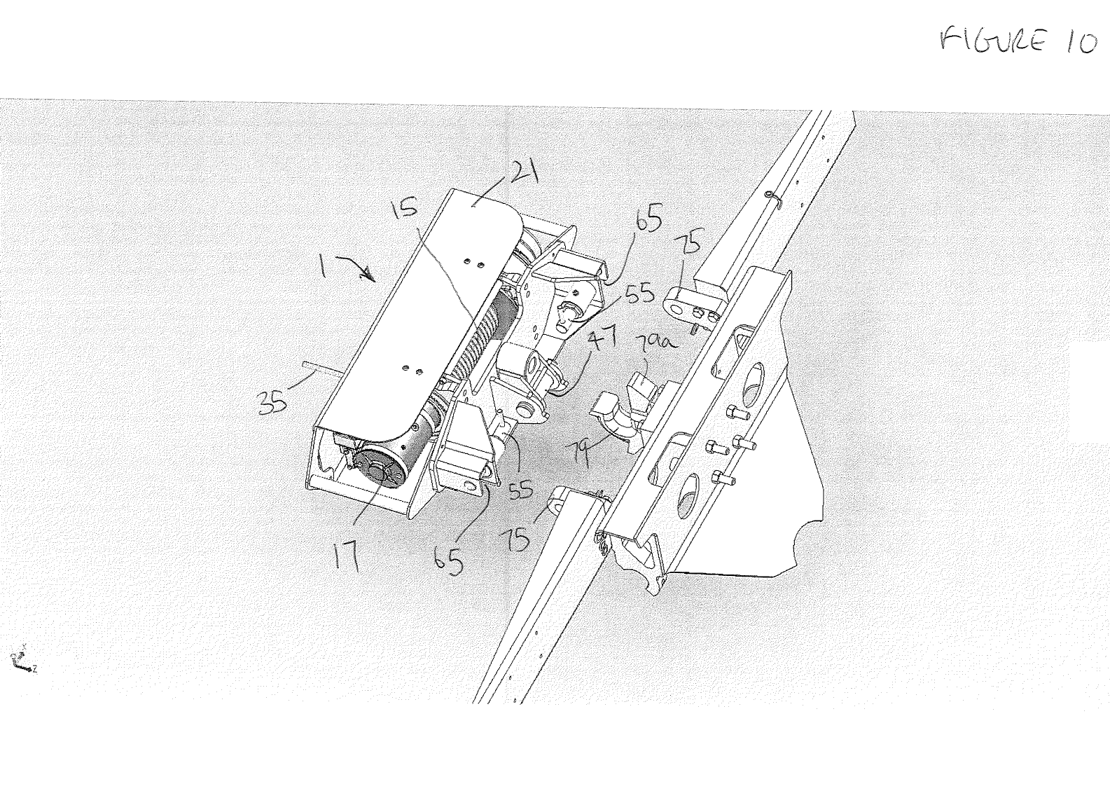

The centre anchor point 9 comprises a hook 79 with a closure part 79a. The closure part 79a is movable to an open position (FIG. 9) that allows the pivot pin 47 of the sleeve 45 on the winch unit 1 to be seated in the hook 79 after the sleeve 45 has been swung to the position shown in FIGS. 10 and 11.

In use, the winch unit 1 is fitted to the front or rear of the vehicle according to requirements and the electric motor 17 is connected to a power source on the vehicle by a suitable lead (not shown). The cable 35 is unwound from the cable reel 15 and attached to an object. The object may be a second vehicle which is to be pulled towards the vehicle, for example when using the winch unit 1 to recover the second vehicle. Alternatively, the object may be fixed such as a pole or tree towards which the vehicle is to be pulled, for example when using the winch unit 1 to recover the vehicle. The cable 35 is rewound by actuating the motor 17 through suitable controls (not shown) on the winch unit 1 or the vehicle to rotate the cable reel 15 in a direction to rewind the cable 35. The motor 17 may be a single speed motor or a variable speed motor.

In the above described embodiment, the mounting bracket 19 of the winch unit 1 is configured to be connected to any vehicle having a three point anchor system at the front or rear of the vehicle (or any other suitable position on the vehicle) that is compatible with the three point coupling system on the bracket 19. In this way, the mounting bracket 19 can be attached to the vehicle without requiring any modification of the vehicle. The coupling points on the bracket 19 are of a quick connect/disconnect type such that the winch unit 1 can be connected to and detached from the vehicle without requiring any tools. In this way, there are no loose fixings or fittings that could be lost or damaged so as to prevent the winch unit 1 being attached to the vehicle.

It will be understood that the invention is not limited to the embodiment above-described and that various modifications can be made within the principle and concept of the invention outlined above. For example, the arrangement and configuration of the coupling points on the winch unit 1 may be altered to suit the anchor points of the vehicles the winch unit is to be connected to. The coupling points provide for a rapid connect/disconnect of the winch unit 1 and to transfer loads from the winch unit 1 to the vehicle at several positions so as to reduce the risk of damage to the coupling points. The number of coupling points may be changed although in general at least two coupling points and more preferably at least three coupling points are provided.

I claim:

1. A winch mounting bracket for attaching to a vehicle, the bracket having at least two coupling points arranged and adapted for engagement with corresponding anchor points on the vehicle to secure releasably said bracket to the vehicle.

2. The winch mounting bracket of claim 1 wherein, the coupling points include at least one latch pin for engagement with a hole at an anchor point on the vehicle.

3. The winch mounting bracket of claim 2 wherein, said latch pin is biased to a latching position in which said latch pin is received in the hole when said bracket is secured to the vehicle.

4. The winch mounting bracket of claim 3 wherein, said latch pin is biased by a spring.

5. The winch mounting bracket of claim 1 wherein, said coupling points include at least one sleeve for engagement with an anchor point on the vehicle.

6. The winch mounting bracket of claim 5 wherein, said at least one sleeve is mounted for engagement with a locking pin or hook on the vehicle.

7. The winch mounting bracket of claim 1 wherein, said bracket has a three point coupling system with a centre coupling point and two outer coupling points disposed on either side of said centre coupling point for engagement with anchor points on the vehicle.

8. The winch mounting bracket of claim 7 wherein, said centre coupling point is a sleeve and said outer coupling points are latch pins.

9. A demountable winch unit for attaching to a vehicle wherein, said winch unit has one or more coupling points for releasable engagement with one or more anchor points on the vehicle.

10. The demountable winch unit of claim 9 wherein, said winch unit includes a winch mounting bracket and the one or more coupling points are provided on said winch mounting bracket for releasably connecting said winch unit to the vehicle.

11. The demountable winch unit of claim 10 wherein, said one or more coupling points include at least one latch pin arranged to engage a hole at an anchor point on the vehicle.

12. The demountable winch unit of claim 11 wherein, said latch pin is biased to a latching position in which said latch pin is received in the hole when said winch mounting bracket is secured to the vehicle.

13. The demountable winch unit of claim 10 wherein, the one or more coupling points include at least one sleeve for engagement with an anchor point on the vehicle.

14. The demountable winch unit of claim 13 wherein, said sleeve is arranged to engage a locking pin or hook on the vehicle.

15. The demountable winch unit of claim 10 wherein, said winch mounting bracket has a three point coupling system with a centre coupling point and two outer coupling points disposed on either side of the centre coupling point, wherein said centre coupling point is a sleeve and said outer coupling points are latch pins.

16. The demountable winch unit of claim 9 wherein, said winch unit includes a cable reel, a motor for rewinding a cable on said cable reel, and a cover for said cable reel and motor.

17. A vehicle and a detachable winch unit releasably connected to the vehicle by co-operating connector means on said winch unit and vehicle, said connector means on said vehicle comprising one or more anchor points and said connector means on said winch unit comprising one or more coupling points.

18. The combination of claim 17 wherein, said one or more coupling points on said winch unit are provided by a mounting bracket for attaching said winch unit to said vehicle.

19. The combination of claim 18 wherein, said mounting bracket has a three point coupling system with a centre coupling point and two outer coupling points disposed on either side of said centre coupling point.

20. The combination of claim 17 wherein, said co-operating connector means are quick connectors that can be connected and disconnected without any tools.
